(19) United States
(12) Patent Application Publication
(10) Pub. No.: US 2015/0164047 A1
(43) Pub. Date: Jun. 18, 2015

(54) EDIBLE CAT TOY

(71) Applicants: Marvin Watts, Scottsdale, AZ (US); Korry Hoglan, Dublin, CA (US)

(72) Inventors: Marvin Watts, Scottsdale, AZ (US); Korry Hoglan, Dublin, CA (US)

(73) Assignee: Urban Pet Haus, LLC, Scottsdale, AZ (US)

(21) Appl. No.: 14/536,191

(22) Filed: Nov. 7, 2014

Related U.S. Application Data
(60) Provisional application No. 61/901,002, filed on Nov. 7, 2013.

(51) Int. Cl. A01K 11/00; A23K 1/14; A23K 1/10; A23K 1/18; A23K 1/00; A23K 1/16

(52) U.S. Cl. CPC A01K 15/026; A23K 1/004; A23K 1/1643; A23K 1/106; A23K 1/1853; A23K 1/14; A23K 1/003

(57) ABSTRACT

An edible toy for cats is made from a base material made of edible material; and an edible coating for the base material. The base material can be any of hypromellose; an edible, water-soluble polysaccharide; fermented tapioca; fish gelatin, beef gelatin, catnip, valerian root or a combination thereof. The base material is combined with water, an inorganic pH buffer and a metal-ion bonding agent. A coating has flavors such as chicken, turkey, beef, pork, lamb, duck, seafood, freshwater fish, grass, catnip, valerian root, lemon grass, sweet grass or a combination thereof. Also disclosed is a method of making edible and medicated toys.

### CROSS-REFERENCE TO RELATED APPLICATION

This application claims the benefit of U.S. Provisional Patent Application Ser. No. 61/901,002, entitled “EDIBLE PET TOY” filed Nov. 7, 2013, and such Provisional Patent Application is incorporated by reference herein in its entirety.

### TECHNICAL FIELD

This invention is related to pet toys and more specifically, to digestible cat toys.

### BACKGROUND OF THE INVENTION

Pet ownership has changed as society has changed. A higher percentage of pet owners acknowledge their pets as being more of a family member than in the recent past. Most owners also realize what's good for their own health is also good for their pets' health. With pet food recalls and unsafe materials and ingredients found in pet products, consumers are seeking solutions, reading labels and buying only products that are rated safe. This awareness with the popularity of pet behaviorist in the media has lead to a more informed and educated consumer. They know more about their particular pets' natural instincts and health needs than ever before. Owners in conjunction with medical treatments and dietary guidelines are also changing their pets' lifestyle in a healthier direction with toys, products and services designed to encourage natural behavior and physical health. The pet industry is responding by focusing on new products and services designed to stimulate and/or simulate a pets' “natural” behavior using safer materials and healthier ingredients.

Some pets require more maintenance than others like following a natural pattern in their daily routine in order to stay healthy mentally and physically. For example cats follow a natural pattern of hunting, eating and then rest or sleep. Domestic cats tend not to follow this pattern due to owners' lifestyles or knowledge of its importance in that sequence. Coupled with the temperament associated with the cat as being an “independent” animal has left many owners with overweight cats, cats with other eating disorders, disease and behavioral problems. Instinctually for domestic cats the “hunt, eat and rest” ritual starts with play (toys). Play before feeding mimics hunting to encourage exercise, to promote hunger, to eat and then rest or sleep.

Cats are incredibly investigatory, and they often use their mouths to explore and will play/attack almost any object to tear it apart and eat it, the desired natural outcome. Things like string and ribbon dangle and move, resembling prey and encouraging a cat's instinct to stalk and chase. When a cat kills a prey animal, it will consume pretty much everything but the head. This includes the entrails, or the long, thin intestines of the animal, which provide great nutritional benefit to the cat. So when a cat starts to eat a piece of ribbon, it mimics the ingestion of a prey's entrails. Studies have proven that some of these chewing behaviors in cats can actually be a form of compulsive behavior. This means there could be a genetic predisposition behind why a cat suckles on fabric or chews on grocery bags. Wool is the most common fabric for kitties to consume. It has been shown that cats who excessively chew on household plants tend to be strictly indoor cats with no access to grass or other vegetable matter. So this investigatory nature to explore different textures via their mouth can actually be a familial disorder. Though it may appear cute, this type of play and chewing behavior can be incredibly dangerous to cats. Felines can become obstructed or seriously injured when they chew and consume various non-digestible toys or household items like string and ribbon. Long, thin objects like ribbon, string, yarn and thread can cause an intestinal blockage. This can quickly become life threatening, and require foreign body surgery to remove these long, thin items.

A search in the pet section in a local retail environment or specialty store for edible and digestible toy products for dogs and cats reveals very little. Edible digestible toys for felines are few to non-existent leaving the majority of toys potentially harmful to cats. In fact, the only feline plant-based toy I could find is a hard and heavy compressed catnip mouse. Other leading cat toys like the furry mouse, artificial feather teaser and wand toys are not digestible at all. Curling ribbon or balloon ribbon is made of polypropylene (PP) a type of polymer (plastic): String, yarn, fur and twine are made of materials like polyester. Artificial feathers are manufactured similarly to synthetic thread and fabric, with the quill part is a plastic tube. Other toy parts eyes, noses and stuffing or fillers are made of various synthetic plastics and are not digestible.

Dogs have more edible non-toxic treats, bones and chew toys. However, dog toys are either made with animal-based ingredients/animal skins or non-toxic plastic which is not digestible and harmful if swallowed. Animal-based raw ingredients and animal skin processing is relatively unregulated. Little control is provided to produce a safe toy, free of dangerous chemicals, bacteria or pollution inherent in the animal-based material processing methods. Plant-based ingredients are being considered as an additional raw material used in conjunction with animal-based ingredients in the production of food, dog chews and toys, not to provide a safer product but to add nutritional value to the end customer the pet.

### BRIEF SUMMARY OF INVENTION

An edible toy for cats includes a base material made of edible material; and an edible coating for the base material. The base material is selected from hypromellose; an edible, water-soluble polysaccharide; fermented tapioca; fish gelatin, beef gelatin, catnip, valerian root and a combination thereof. The base material is combined with water, an inorganic pH buffer and a metal ion bonding agent. The coating includes at least one flavor. The flavor is selected from chicken, turkey, beef, pork, lamb, duck, seafood, freshwater fish, grass, catnip, valerian root, lemon grass, sweet grass and a combination thereof.

In another embodiment there is provided a method for making an edible toy for cats that has the following steps: a) providing a base material selected from hypromellose; edible, water-soluble polysaccharide; fermented tapioca; fish gelatin, beef gelatin, catnip valerian root and a combination thereof; b) providing water, an inorganic pH buffer and a metal-ion bonding agent; c) providing a flavored coating material with flavors selected from chicken, turkey, beef, pork, lamb, duck, seafood, freshwater fish, grass, catnip, valerian root, lemon grass, sweet grass and a combination thereof; d) combining the base material with water, inorganic pH buffer and the metal-ion bonding agent to form a base combination; e) subjecting the base combination to heat and a plastic manufacturing process; and f) coating the processed base combination with the flavored coating material.

The step of plastic manufacturing process can be performed by thermoforming, injection molding, vacuum forming, extrusion and compression, the manufacturing process being selected depending on the shape to be produced.

An objective of the present invention is to create safe, natural, “plant-based” digestible materials imitating the properties and functions—look, feel and other characteristics—of existing pet toy materials providing familiarity to both pet parents and pets. Imitating the characteristics of balloon ribbon for cats is an example: Our new invention shreds easily so claws don't get caught and play stays fun and continuous while the tensile strength massages the gums when cats bite or chew on it. Digestible materials provide safe alternatives to the pet toy manufacturers, producers and the growing “do-it-yourself” consumer market looking for safer healthier options.

Desirable shapes include ribbons, feathers, furs, fibers, paper, cardboard and other toy parts including bugs, eyes, ears, patterns for forming body parts and fillers. All are covered in the various manufacturing processes above, and additionally woven parts like digestible fabrics and labels.

The present invention utilizes processing and manufacturing with any type of thermoforming, injection molding, vacuum forming, extrusion, and compression processes to produce digestible materials, products and packaging including but not limited to ribbons, feathers, furs, fibers, paper, cardboard and other toy parts including bugs, eyes, ears, patterns for forming body parts and fillers. All are covered in the various manufacturing processes including woven parts like digestible fabrics and labels.

In certain embodiments, the digestible materials have flavor ingredients added or coating for enhancing or inducing play and/or as part of a treat or to help deliver a medication.

In certain embodiments, the digestible materials have additional ingredients or coatings for the delivery of medications, nutrients and/or mood altering herbs and oils. Edible digestible toys are used for more than play, such as for easier and more effective administering of medical treatments and/or behavior modification. Delivering nutrients, grass or other vegetable matter through a toy instead of household plants helps indoor cats satisfy a dietary need and stimulus instead of excessively chewing on possibly poisonous household plants.

To the accomplishment of the foregoing and related ends, certain illustrative aspects of the invention are described herein in connection with the following description and the annexed drawings. These aspects are indicative, however, of but a few of the various ways in which the principles of the invention is intended to include all such aspects and their equivalents. Other advantages and novel features of the invention may become apparent from the following detailed description of the invention when considered in conjunction with the drawings.

### BRIEF DESCRIPTION OF THE DRAWINGS

Many types of pets if unsupervised will try to destroy any toy and eat what they can. Mostly, these toys are indigestible and can even harm pets. Thus, what is needed are digestible materials for manufacturing edible pet toys. Edible pet toys can be used to facilitate a desired outcome through play or as part of a snack, or even for the delivery of medications, nutrients and mood altering herbs and oils with the goal of being ingested and digested. We disclose herein safe edible and digestible materials as an alternative that will benefit pets, their human companions and the pet industry.

FIG. 1 illustrates the plan view of a continuous extruded digestible toy or material 100 in ribbon form for cat toys.

FIG. 2 Illustrates the perspective view of the continuous extruded digestible toy or material 100 ribbon.

FIG. 3 is an enlarged cross section perspective view of the continuous extruded digestible toy or material 100 ribbon.

FIG. 4 is an enlarged partial view of the cross section of the extruded digestible toy or material 100 ribbon comprising of base toy or material 100 and the flavor coating 200 shown on both sides of FIG. 3.

FIG. 5 illustrates a perspective view of the continuous extruded digestible toy or material 100 ribbon shown smooth. Ribbon material available in a variety of standard colors and coatings for customization used in branding.

FIG. 6 illustrates a perspective view the continuous extruded digestible toy or material 100 ribbon shown embossed.

FIG. 7 illustrates a flow chart of an extrusion method for manufacturing digestible material including ribbon 100, fibers including string 300, thread 400 twine, fiber/filament 500 for use in fur parts and feather parts in accordance with the present invention.

FIG. 8 illustrates the plan view of a continuous extruded digestible material 300 shown in thread form for making, 400 in string form, 500 in fiber/filament form. Fibers 500 are used in making fur, feathers, twine, fabric, labels, woven ribbon, paper and cardboard.

FIG. 9 illustrates a view of an exemplary digestible toy shown in ribbon teaser form.

FIG. 10 is a view of digestible toy material 600 shown in feather form. Digestible feathers are made with fibers 500.

FIG. 11 illustrates a view of an exemplary digestible feather toy shown as feather teaser.

FIG. 12 illustrates a view of an exemplary digestible material toy 700 shown as a molded bug using digestible string 400 to attach to wand. Toy bugs can be molded or made from all digestible materials and manufacturing methods in accordance with the present invention.

FIG. 13 illustrates a view of an exemplary complete wand toy shown with bug 700. Wand toy attachments can be made with digestible materials including feathers 600, ribbons 100, fibers including thread 300, string 400 and filament 500.

FIG. 14 illustrates a view of an exemplary digestible toy shown as a mouse. Mice can be made with digestible materials including feathers 600, ribbons 100, fibers including thread 300, string 400 and filament 500 to make the fur sheets, fabric sheets, thread, and feathers.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well known material processes are shown in flow diagram form in order to facilitate describing the invention.

The present invention identifies a need for providing safe digestible materials for forming and manufacturing pet toys that not only provide entertainment for the pet mentally and physically, but can also offer other benefits relating to the health of a pet through the digestion process.

Many chew toys and treats are known in the arts or are commercially available as a finished toy product primarily for dogs. However, few if any meet the particular and different needs of cats. Sadly, the majority of pet toys are not digestible.

Many edible substrates are known in the art or are commercially available. For example, edible papers and edible sheet material such as edible frosting material can be obtained from Lucks Food Decorating Company (www.lucks.com), DecoPac Inc. (www.decopac.com). In addition, a number of U.S. Patents describe edible substrates and systems and methods of printing images thereon (e.g., U.S. Pat. No. 7,128,938, U.S. Pat. No. 6,652,897, U.S. Pat. No. 6,616,958, U.S. Pat. No. 6,582.742). Digestible material useful in the invention may be of the pre-printed type. These embodiments are for illustrative purposes only and are not intended to limit the invention.

The raw ingredients and formulations of the present invention produce a wide range of digestible materials using similar manufacturing processes. The digestible material products can be processed by any conventional method, for example, extrusion or injection molding makes digestible materials like ribbon, string or thread for fabric, fur parts and feather parts easy to manufacture. Ingredient substitutions, additions and/or flavor and medicinal coating steps are similar to the existing production processes.

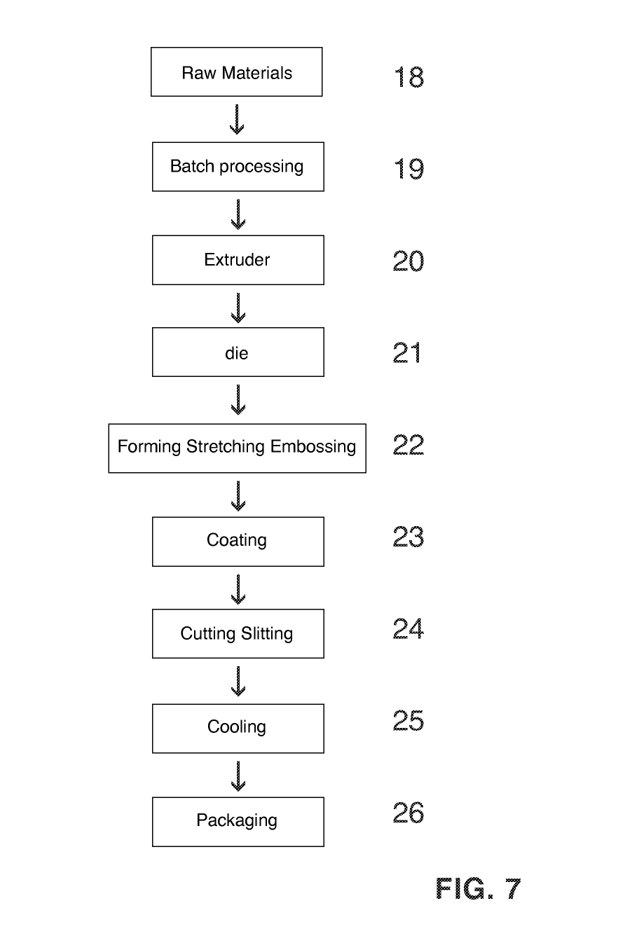

FIG. 7 illustrates a flow diagram of a basic extrusion process that can be used to manufacture the present invention in many forms. Generally the extrusion process begins with placing the raw materials 18 through a blending, grinding and batching process 19, for a time period sufficient to adequately distribute all ingredients throughout the resultant mixture. After the raw materials have been mixed, the material moves through an extruder 20. This example involves one extruder (twin or single screw) filling a die 21. The product comes out of the die 21, is conveyed to further processing including but not limited to, forming, stretching, embossing 22 or coating. Once the material is coated 23, the coated material is ready to be cut or slit 24, and if necessary cooled 25 then packaged 26.

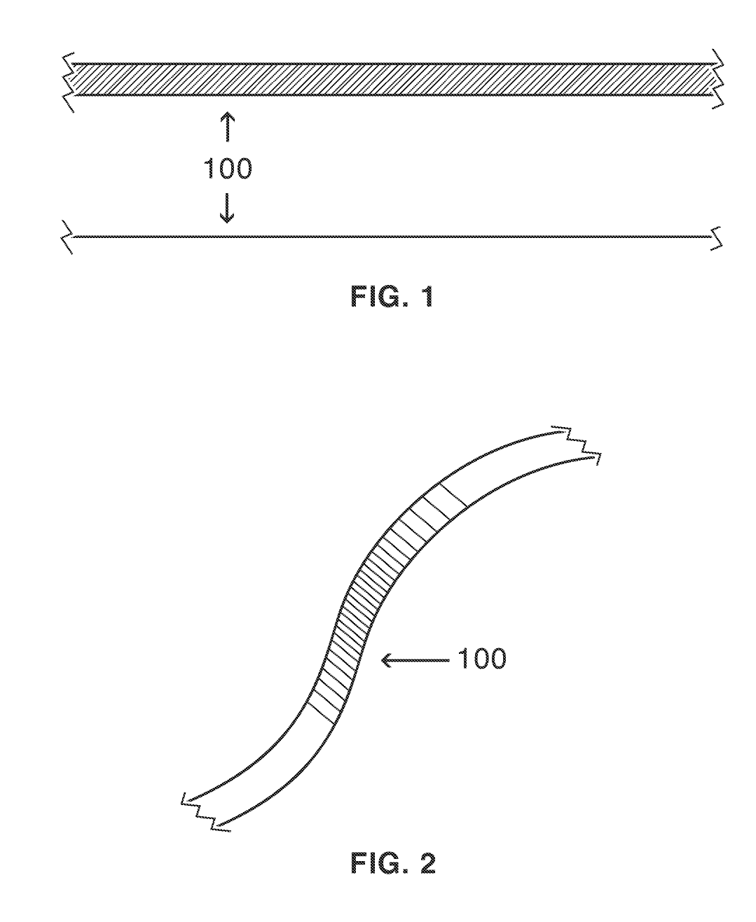

Referring now to FIG. 1 there is illustrated a plan view of an exemplary digestible ribbon toy or digestible ribbon material 100 for a cat. In a preferred embodiment of the present invention as digestible ribbon 100 is formed by extrusion (FIG. 7) forcing hot molten “plant-based” formula through a flat die 21 that creates a large thin continuous sheet stretched and embossed 22. These thin sheets are slit into narrower ribbon widths on a slitting machine 24 and coated 23 with a flavor as part of a treat, or the delivery of medications, nutrients and mood altering herbs and oils then spooled and packaged.

Referring now to FIG. 2, there is illustrated a perspective view of an exemplary digestible toy or ribbon material 100 In accordance with the present invention of providing a totally digestible toy or material therein, the ribbon 100 is manufactured mostly or entirely of natural ingredients and compounds, e.g., hypromellose (HPMC) and/or: a vegetable-derived, slow dissolving, water-soluble polysaccharide; catnip oil; valerian root oil; fish gelatin; beef gelatin or similar substance. The ribbon 100 can be used in feline toys like for play, as part of a snack, for the delivery of medications, nutrients and mood altering herbs/oils. The ribbon 100 is gradually shredded during play or chewed away as the cat attempts to eat the toy. The ribbon 100 manufacturing process produces a relatively durable material with the same look, feel and other characteristics of curling ribbon or balloon ribbon material able to resist handling processes and pet owner handling prior to exposure to the pet. The main ingredient hypromellose (hydroxypropyl-methylcellulose or HPMC) is available at Parchem (www.parchem.com) and Ashland Inc (www.ashland.com). Pullulan, a brand of fermented Tapioca, is available at (www.parchem.com), TCI America (www.tcichemicals.com).

One embodiment of a component formulation for a digestible ribbon according to this disclosure includes the following ingredients:

| Ingredient | Amount, wt, % |
|---|---|
| Modified cellulose or Polysaccharide | 40-80 |
| Water | 3-8 |
| Inorganic pH buffer | 3-6 |
| Metal ion bonding agent | 3-6 |

The modified cellulose/polysaccharide optionally contains catnip, valerian root, fish gelatin or beef gelatin.

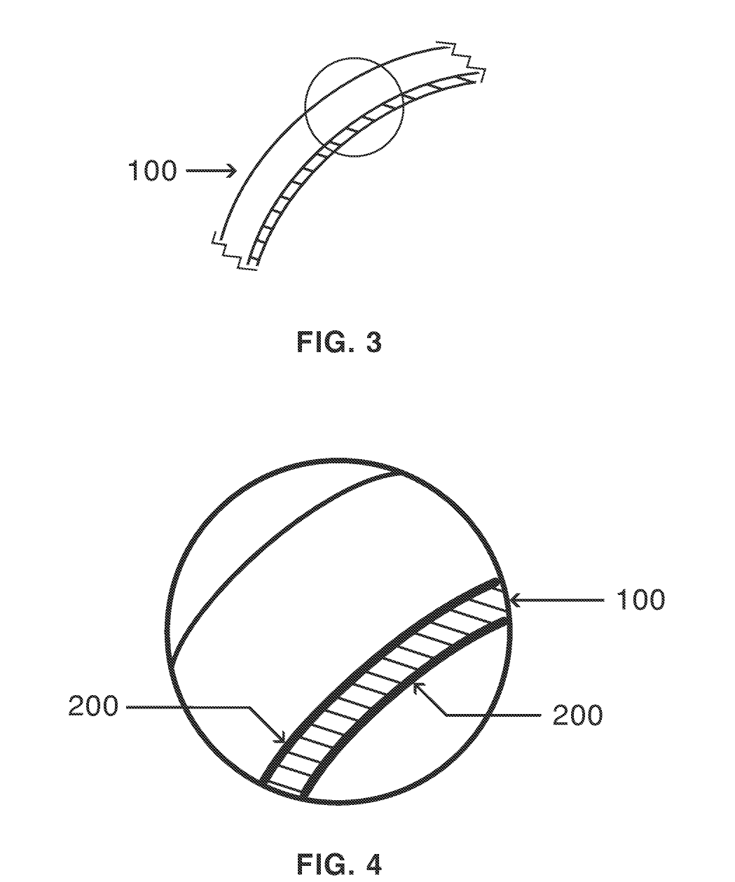

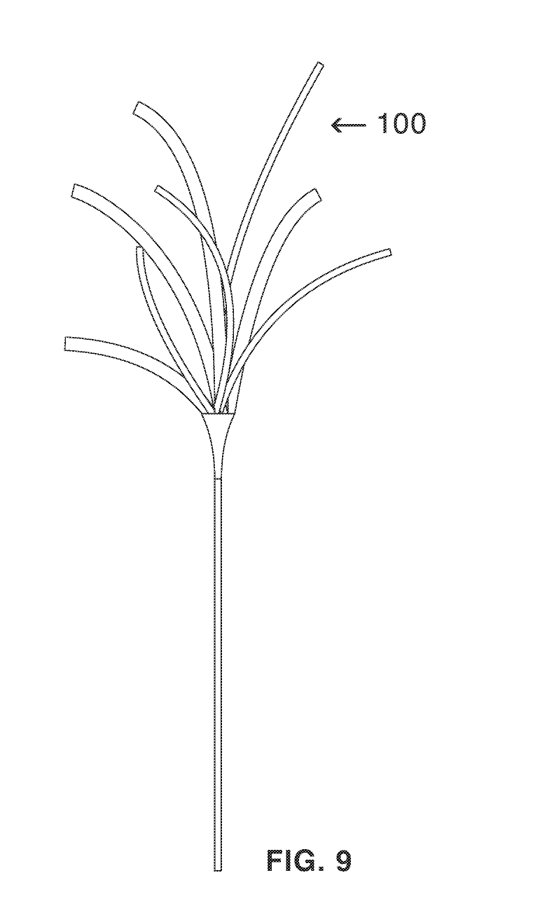

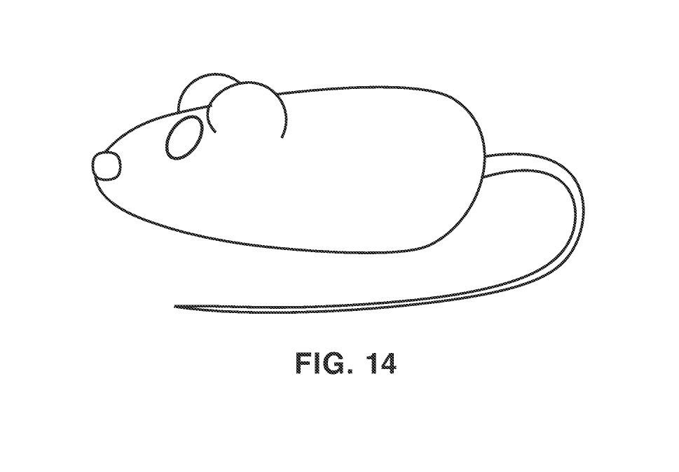

Referring now to FIG. 3, there is illustrated an enlarged perspective view of an exemplary digestible toy or ribbon material 100 to replace curling ribbon or balloon ribbon, but utilizing the same manufacturing process with digestible raw materials for a different purpose. Uses include safe cat teasing toys and ribbon teaser (shown in FIG. 9) or parts for other toys like the tail of a mouse shown in FIG. 14 or additional material for use in other digestible toys.

Referring now to FIG. 4, there is illustrated an enlarged cross section view of the digestible toy 100 comprised of the following:

Base material—hypromellose (HPMC) and/or: vegetable-derived, slow dissolving, water-soluble polysaccharides; fish gelatin; beef gelatin; catnip oil; valerian root oil or other digestible substrates.

Coating 200—At least one flavor including but not limited to chicken, turkey, beef, pork, lamb, duck, seafood and freshwater fish, grasses and herbs like catnip, valerian root lemon grass, sweet grass, and other flavors cats are attracted to.

The digestible toy 100 can be used in feline toys as part of a snack, for the delivery of medications, nutrients and mood altering herbs/oils. The edible coating 200 can be used for flavor. In another embodiment, the edible coating is used to deliver medications, nutrients and mood altering herbs/oils.

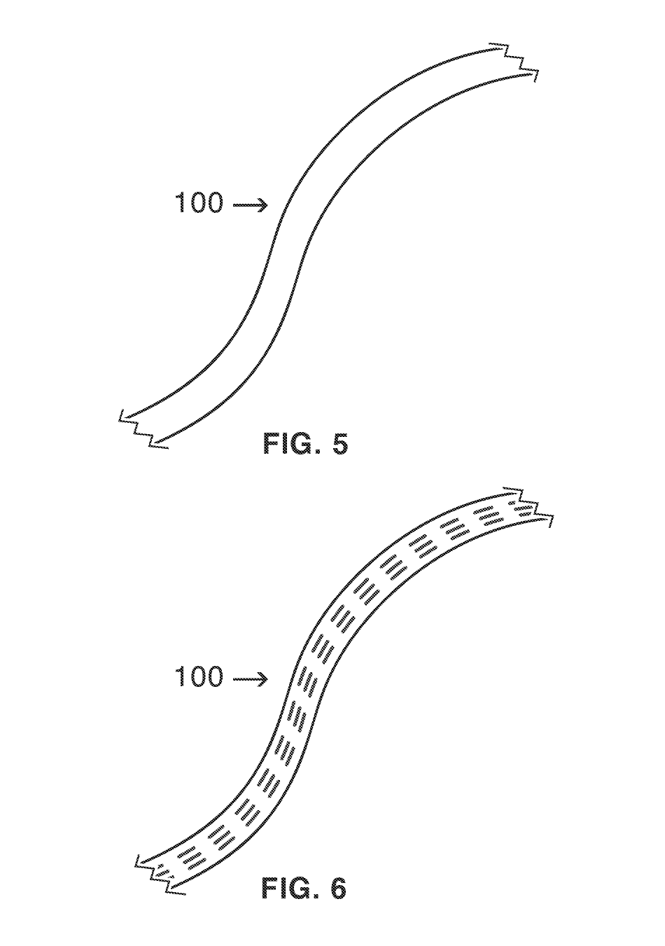

Referring now to FIG. 5, the ribbon 100 probably has a smooth surface and a variety of colors for customizing and branding.

Referring now to FIG. 6, the ribbon 100 is provided in a variety of embodiments including embossed textures and colors that enable customizing and branding.

The digestible material 100 is suitable for manufacturing toys though the ribbon extrusion process to produce edible ribbon having a width between about ⅜″ to 36″. The ribbons are preferably manufactured in lengths from 5′ long to a continuous roll. Basically a variety of processes can be used, particularly thermoforming process (injection, vacuum forming, extrusion and compression processes).

The digestible coating 200, useful for flavor and/or delivery of ingredients including but not limited to medications, nutrients and mood altering herbs/oils, is preferably imparted after ribbon extrusion or injection molding.

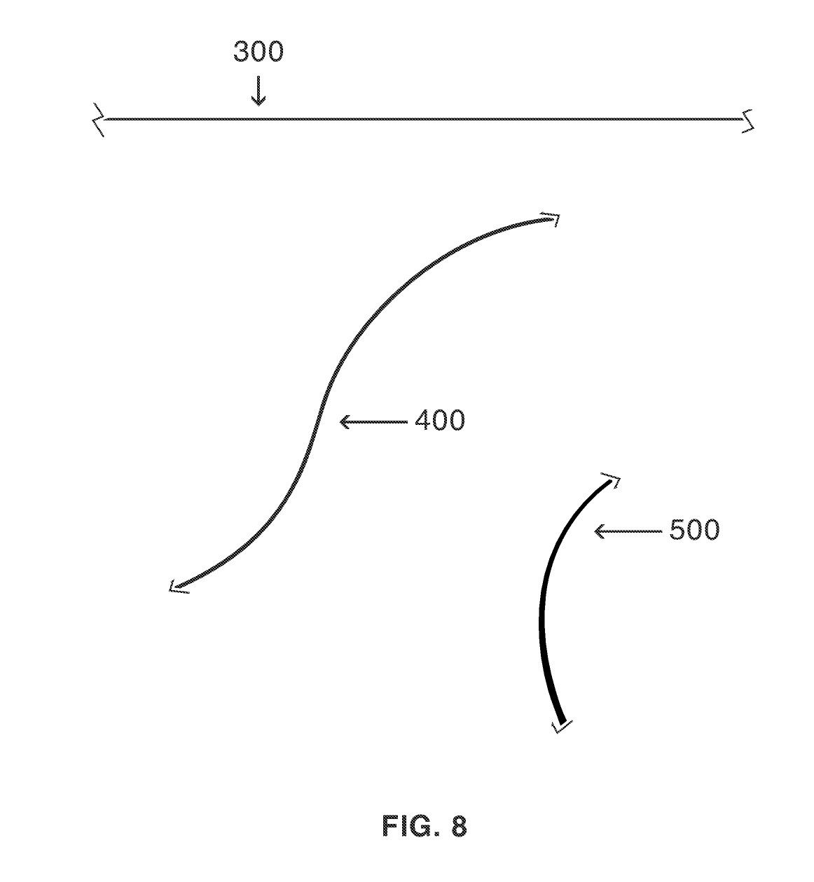

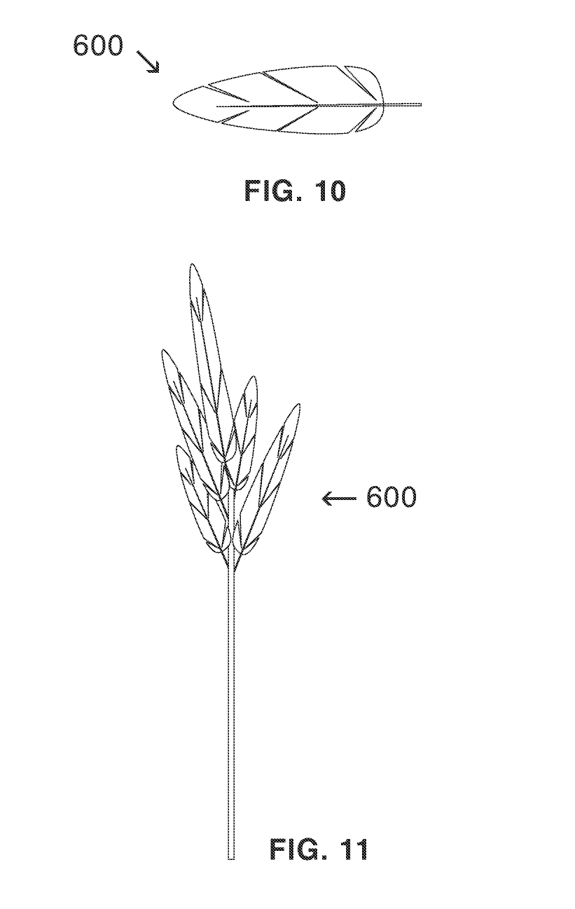

The toy of the digestible material can be made by a variety of manufacturing processes and in a variety of shapes. Ribbon 100, string 300, fur and feather parts are preferably made by the extrusion process shown in FIG. 7. An artificial feather (FIG. 10) is used in a feather teaser. FIG. 11 is made from filaments from FIG. 8 manufactured in a similar extrusion method used to create synthetic thread and fabric. Fur, twine, fabric, labels, woven ribbon, paper and cardboard are made from the digestible fibers using an appropriate process. Fur for use in a mouse (FIG. 14) is made using different methods. The slowest method is a weaving process, then tufting and two types of knitting for faster production.

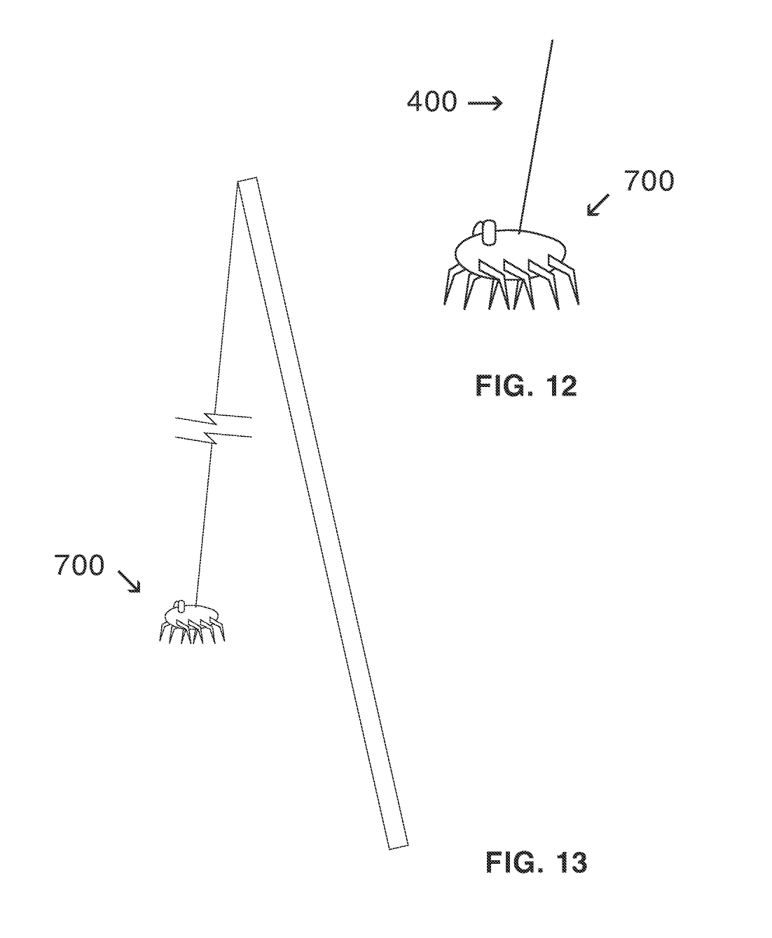

Referring now to FIG. 13, we show a perspective view of an exemplary wand with a digestible toy bug 700 made by injection molding shown larger in FIG. 12. Toy bugs can be molded or made from digestible materials and manufacturing methods in accordance with the present invention including feathers 600, fur, twine, fabric., labels, woven ribbon, paper and cardboard.

Herein we have described how toys are made from digestible raw materials processed with any type of thermoforming, injection, vacuum forming, extrusion, and compression processes to produce digestible materials, products and packaging. In use, the cat is presented with an eye-catching toy with which to play by tearing apart, pouncing, etc. The cat naturally ingests the toy after playing with it.

Almost any orally administered medication can be added to either the toy's base material or coating. Cats and dogs are much more quickly and effectively medicated with a drug-impregnated chewable toy. It obviates the difficulties of trying to force the medication into the pet's mouth or hiding it in desirable food; either way pets spit out the noxiously flavored medication. The inventive edible pet treat is impregnated with flavors as well as medication and is actually sought out and digested for more effective treatment and less owner aggravation and time. Current popular medications are listed below:

Anti-inflammatories (non-steroids) include but are not limited to: Aspirin (Acetylsalicylic Acid), Deracoxib (Deramaxx®), Etodolac (EtoGesic®), Firocoxib (Previcox®), Meloxicam (Metacam®), Piroxicam (Feldene®) and Tepoxalin (Zubrin®).

Antibiotics include but are not limited to: Aminopenicillins (Ampicillin, Amoxicillin), Amoxicillin/Clavulanate (Clavamox®, Augmentin®), Cephalosporins (Cephalexin, Simplicef™), Ciprofloxacin (Cipro®), Clindamycin (Antirobe®), Doxycycline (Vibramycin®), Enrofloxacin (Baytril®), Erythromycin, Extended-spectrum Penicillins (Carbenicillin), Kanamycin (Amforol), Lincomycin (Lincocin®), Marbofloxacin (Zeniquin®), Metronidazole (Flagyl®), Novobiocin (Albaplex®, Delta Albaplex®), Orbifloxacin (Orbax®), Penicillin G (Procaine, Benzathine, or Aqueous Penicillin G), Penicillinase-Resistant Penicillins (Cloxacillin), Sulfadimethoxine (Albon®), Sulfadimethoxine/Ormetoprim (Primor®), Tetracycline, Trimethoprim/Sulfa (Bactrim™, Septra, Tribrissen®) and Tylosin (Tylan®).

Antifungal Medications include but are not limited to: Griseofulvin (Fulvicin®) and Itraconazole (Sporanox®).

Antihistamines include but are not limited to: Chlorpheniramine, Clemastine (Tavist®), Cyproheptadine (Periactin®), Dimenhydrinate (Dramamine®), Diphenhydramine (Benadryl®) and Hydroxyzine (Atarax®).

Antiprotozoal Medications include but are not limited to: Metronidazole (Flagyl®) and Sulfadimethoxine (Albon®).

Behavior Modification Medications include but are not limited to: Alprazolam (Xanax®).

Antidepressants include but are not limited to: Buspirone (Buspar®), Clomipramine (ClomiCalm®), Diazepam (Valium®), Fluoxetine (Reconcile®, Prozac®), Selegiline (Deprenyl®, Anipryl®) and Sertraline (Zoloft®).

Medications used for Central Nervous System, Epilepsy, Seizure Medications include but are not limited to: Acepromazine® (Promace®), Aminocaproic Acid (Amicar), Diazepam (Valium®), Gabapentin (Neurontin), Methocarbamol (Robaxin®, Robaxin®-V), Pentobarbital (Nembutal Sodium), Phenobarbital (Solfoton), Phenytoin (Dilantin®), Potassium Bromide (KBr).

Digestive Tract, Liver, and Pancreas Medications include but are not limited to: Aminopentamide (Centrine), Antacids/Phosphate Binders (Maalox, Milk of Magnesia), Bismuth Subsalicylate (Pepto Bismol), Cimetidine (Tagamet®), Cisapride, Dicyclomine (Bentyl), Dimenhydrinate (Dramamine®), Diphenhydramine (Benadryl®), Dirlotapide (Slentrol) and

Famotidine (Pepcid®).

Hairball Remedies and Laxatives include but are not limited to: Kanamycin/Bismuth/Aluminum Magnesium Silicate (Amforol®), Loperamide (Imodium), Maropitant Citrate (Cerenia®), Metoclopramide (Reglan®), Misoprostol (Cytotec®) and Omeprazole (Prilosec).

Pancreatic Enzymes (Pancrelipase®, Pancrezyme®, Viokase®) include but are not limited to: Psyllium (Metamucil), Ranitidine (Zantac®), S-Adenosylmethionine (Denosyl® SD-4), Sucralfate (Carafate®), Sulfasalazine (Azulfidine EN-tabs®) and Ursodiol (Actigall).

Diuretics ('Water Pills') include but are not limited to: Furosemide (Lasix®, Salix®).

Heart & Blood Pressure Medications include but are not limited to: Aminophylline and Theophylline, Digoxin, Furosemide (Lasix®, Salix®), Pimobendan (Vetmedin), Sotalol, Spironolactone, Sprionolactone plus Hydrochlorothiazide (Aldactazide) and Terbutaline.

Heartworm Preventives and Treatments include but are not limited to: Diethylcarbamazine, Ivermectin, Melarsomine, Milbemycin Oxime, Moxidectin (Advantage Multi), Selamectin and Thiacetarsamide Sodium.

Hormones-Endocrine-Reproduction-related Treatments include but are not limited to: Azathioprine, Budesonide, Corticosteroids (Steroids, Predisone, etc.), Corticosteroids: Minimize Side Effects, Desoxycorticosterone Pivalate (DOCP), Diethylstilbestrol, Erythropoietin, Estrogen-Estradiol Cypionate, Fludrocortisone Acetate, Insulin, Ketoconazole (Nizoral®), Levothyroxine, Methimazole, Mibolerone, Mitotane, Oxytocin, Selegiline (Deprenyl®, Anipryl®) and Stanozolol.

Immune System-Anti-cancer Treatments include but are not limited to: Acemannan, Corticosteroids (Steroids, Predisone, etc.), Cyclosporine-Ophthalmic, Cyclosporine-Oral (Sandimmune®, Neoral®, Atopica®), Methotrexate and Piroxicam (Feldene®).

Pain Relievers include but are not limited to: Aspirin (Acetylsalicylic Acid), Butorphanol Tartrate, Carprofen (Rimadyl®, Novox®), Deracoxib (Deramaxx®), Etodolac (EtoGesic®), Fentanyl, Firocoxib (Previcox®), Gabapentin (Neurontin), Meloxicam (Metacam®), Phenylbutazone, Tepoxalin (Zubrin®) and Tramadol (Ultram®).

Respiratory System Treatments include but are not limited to: Albuterol, Aminophylline and Theophylline, Butorphanol Tartrate, Cyproheptadine (Periactin®), Dextromethorphan, Diphenhydramine (Benadryl®), Hydrocodone-Homatropine MBr or Guaifenesin, Montelukast, Trimeprazine and Prednisolone (Temaril-P®).

Urinary Tract & Kidney Medications include but are not limited to: Allopurinol, Amlodipine, Ammonium Chloride, Antacids/Phosphate Binders (Maalox, Milk of Magnesia), Benazepril, Calcitriol, Calcium Acetate, Citrate Salts, Dicyclomine (Bentyl), Diethylstilbestrol, Erythropoietin, Estrogen-Estradiol Cypionate, Lisinopril, Methionine and Phenylpropanolamine.

Vitamins-Minerals-Potassium Supplements-Electrolytes-Nutraceuticals include but are not limited to: Calcitriol, Cyanocobalamin, Glycosaminoglycan, Lactated Ringer's Injection (LRS), Normosol-R, Isolyte-S, & Plasmalyte A, Omega Fatty Acids, Polysulfated Glycosaminoglycan, Potassium Chloride Injectable, Potassium Supplements, Sodium Chloride 0.45%, Sodium Chloride 0.9%, Vitamin B Complex and Vitamin K1 (Phytonadione, Mephyton®).

Wormers and Anti-parasitics include but are not limited to: Diethylcarbamazine, Epsiprantel, Fenbendazole, midacloprid plus Moxidectin (Advantage Multi), Ivermectin, Mebendazole, Milbemycin Oxime, Moxidectin (Advantage Multi), Piperazine, Praziquantel, Pyrantel Pamoate, Selamectin and Trimethoprim/Sulfa (Bactrim™, Septra, Tribrissen®).

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An edible toy for cats, the edible toy comprising
a. a base material made of edible material; and
b. an edible coating for the base material.

2. The edible toy of claim 1 wherein the base material is selected from hypromellose; an edible, water-soluble polysaccharide; fermented tapioca; fish gelatin, beef gelatin, catnip, valerian root and a combination thereof.

3. The edible toy of claim 2 wherein the base material is combined with water, an inorganic pH buffer and a metal ion bonding agent.

4. The edible toy of claim 1, wherein the coating comprises at least one flavor.

5. The flavor of claim 4 selected from chicken, turkey, beef, pork, lamb, duck, seafood, freshwater fish, grass, catnip, valerian root, lemon grass, sweet grass and a combination thereof

6. A method for making an edible toy for cats, the method comprising the following steps
a. providing a base material selected from hypromellose; edible, water-soluble polysaccharide; fermented tapioca; fish gelatin, beef gelatin, catnip valerian root and a combination thereof;
b. providing water, an inorganic pH buffer and a metal-ion bonding agent;
c. providing a flavored coating material with flavors selected from chicken, turkey, beef, pork, lamb, duck, seafood, freshwater fish, grass, catnip, valerian root, lemon grass, sweet grass and a combination thereof;
d. combining the base material with water, inorganic pH buffer and the metal-ion bonding agent to form a base combination;
e. subjecting the base combination to heat and a plastic manufacturing process; and
f. coating the processed base combination with the flavored coating material.

7. The method of claim 6 wherein the plastic manufacturing process is selected from thermoforming, injection molding, vacuum forming, extrusion and compression, the manufacturing process being selected depending on the shape to be produced.
